(19) United States
(12) Patent Application Publication
(10) Pub. No.: US 2011/0054986 A1
(43) Pub. Date: Mar. 3, 2011

(54) DONATION FACILITATOR SOCIAL NETWORK

(75) Inventors: Idan Rubin, Seattle, WA (US); Ori Kremer, Redmond, WA (US); Raju Ayyagari, New York, NY (US)

(73) Assignee: WiseDonation.com, Seattle, WA (US)

(21) Appl. No.: 12/549,866

(22) Filed: Aug. 28, 2009

(51) Int. Cl. G06Q 40/00; G06Q 50/00; G06Q 99/00

(52) U.S. Cl. 705/14.2; 705/14.19; 705/39; 705/319

(57) ABSTRACT

Methods, techniques and systems for electronically facilitating donations are provided. Example embodiments provide a Donation Facilitator Social Network (“DFSN”), which enables users (participants in the DFSN) to more easily donate to the organizations, especially non-profits or NGOs, that are most suitable to their interests and desires. In one embodiment, the DFSN comprises one or more of an NGO Search Engine; an NGO Suggestion Engine; a weighting and ranking engine; account management; sponsor integration support; donor matching services; a DFSN API; and one or more data repositories such as NGO data repository; and a user data repository, which maintains information on the various preferences, weightings, donation accounts of the participants. These components cooperate to automatically distribute funds to a weighted list of organizations based upon donation specifications amongst other criteria.

### TECHNICAL FIELD

The present disclosure relates to methods, techniques, and systems for facilitating online donations and, in particular, to methods, techniques, and systems for helping users donate online to organizations using their social connectedness.

### BACKGROUND

Generally speaking, individuals and organizations wish to make a difference in the communities they live in and in the causes in which they believe. Typically, each individual manages his or her donations to different organizations differently—and makes donations either on a set schedule to a set of organizations, or instead on an ad-hoc basis, or somewhere in between. It is often difficult for people to find the different organizations in which they may be interested in donating. Moreover, individuals want to know where their money goes and to learn about the organizations activities/events/contributions etc. to which they contribute. Organizations are aware of this and subsequently spent lots of advertising dollars to attract and maintain their donors.

Over the years, different types of computerized systems have been developed to facilitate donating to organizations. Some of these systems offer the ability for employers to participate in employee donations. Others have made it easier for individuals to make and manage recurring donations and to fund special activities, such as to provide aid for disasters when they occur. In addition, other systems have expanded the currency for donations, so that people can transfer stock, use loyalty points, and the like. Although it has become easier for an individual to automatically contribute small donations on a regular basis to a set of organizations, the individual may be still confounded by the endless number of possible recipients.

### BRIEF DESCRIPTION OF THE DRAWINGS

FIG. 1 is a block diagram of an example donation facilitator social networking application for creating and managing personal donations in a networked environment.

FIG. 2 is an example block diagram of components of an example donation facilitator social network.

FIG. 3 is an example screen display of example donation accounts within an example donation facilitator social network.

FIG. 4 is an example screen display of an example arrangement of one time fixed donations within example donation account in an example donation facilitator social network.

FIG. 5 is an example screen display of an example arrangement of weighted daily donations within an example account in an example donation facilitator social network.

FIG. 6 is an example screen display of an example arrangement of a disaster fund donations in an example donation facilitator social network.

FIG. 7 is an example flow diagram of an overview of an example donation process in an example donation facilitator social network system.

FIG. 8 is an example flow diagram of private sector gift matching in an example donation facilitator social network.

FIGS. 9A-9J are example screen displays of example features in an example donation facilitator social network application for implementing an automated weighted donation system.

FIG. 10 is an example block diagram of a computing system for practicing embodiments of an example donation facilitator social network system.

### DETAILED DESCRIPTION

Embodiments described herein provide enhanced computer- and online donations to organizations such as non-government organizations (NGOs). Example embodiments provide a Donation Facilitator Social Network (“DFSN”), which enables users (participants in the DFSN) to more easily donate to the organizations, especially non-profits or NGOs, that are most suitable to their interests and desires. Moreover, the DFSN allows a participant to manage and share information with friends, NGOs, staff, colleagues, etc. concerning a multitude of donations of any size, including very small ones, on a frequent basis. This way everybody's donation counts, and is visible to others as desired, regardless of the magnitude or frequency of the donation—just consistent with the participant's desire for publicity or privacy. In addition, a participant can donate to a multitude of organizations that the participant weights and ranks by a variety of factors, and the DFSN automatically handles the subsequent distributions based upon the participant's budget and designated frequency.

Also, the DFSN is extendible, for example with plug-in applications/code that allows additional functionality such as employer donor matching services, private donor matching services, sponsored donation support (for example, as a result of advertisement inclusion or other user experiences), integration of auctions for donation purposes, social recommendations, etc. Other applications can be supported.

The advent of social networking has brought many users together that share common interests over one or more subject areas. With extensive use of online capacities, it is now possible to share data, events, and such, with ones friends, colleagues, co-workers, and organizations worldwide. The DFSN takes advantage of social network metaphors to share information, including information about organizations, suggestions, ratings, etc. in a particular donor's “donor social network” as maintained by the DFSN. For example, users can find out about the donations of their “friends” and sponsors, what organizations are popular, the extent of the giving, as well as finding out the particulars of an organization, global and private usage statistics, etc. In addition, NGOs can interact and provide updates, statistics, and timely news to their donors and sponsors. Accordingly, one can describe the DFSN as applying a holism approach to donating.

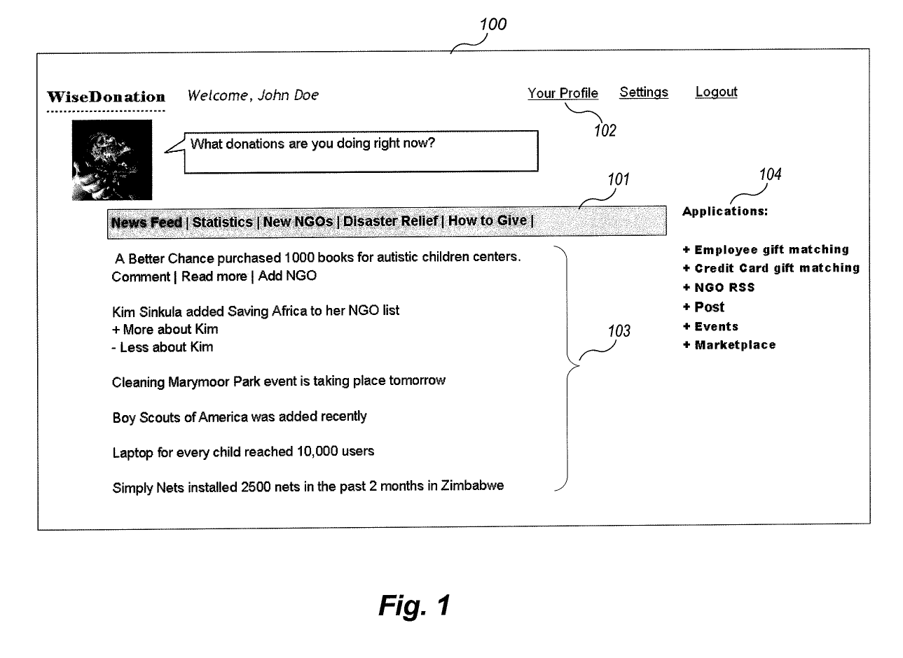

FIG. 1 is a block diagram of an example donation facilitator social networking application for creating and managing personal donations in a social network environment. FIG. 1 shows an example user interface web page 100 for an example embodiment of a DFSN according to the techniques described here. The participant “John Doe” has logged in and is welcomed by social news 103 pertaining to donations. As shown in the action bar 101, in addition to donation news, the participant can find out statistics about organizations of interest, what NGOs have been added to the system, what disaster relief has been administered or is needed, and instructions on how to donate in the system. Other actions (not shown), for example sponsor “give-back” activities triggered by donor inclusion of sponsor advertising, can also be supported. Application plug-in area 104 shows several examples of other applications that are supported in an example embodiment, namely: employee gift matching; credit card (sponsor) gift matching; RSS feeds for particular NGOs; support for posting news about your donations; donation event information; an auction marketplace that gives donations to NGOs, etc. Different and other applications can be supported. Also, any user interface that offers the functions of the DFSN could be similarly incorporated, including less visual interfaces oriented to other types of devices and interfaces embedded in other program products.

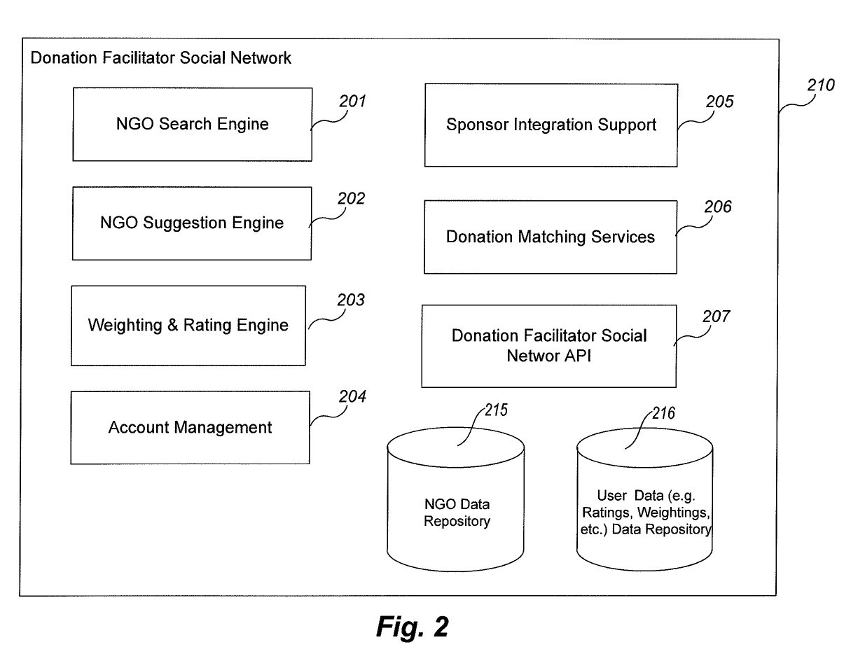

FIG. 2 is an example block diagram of components of an example donation facilitator social network. In one embodiment, the Donation Facilitator Social Network System comprises one or more functional components/modules that work together to facilitate automated donations to NGOs on behalf of one or more participants as described herein. These components may be implemented in software or hardware or a combination of both. In addition, as described further below, each component may be implemented as a computing system, in a client-server combination such as services provided to provide pages to a client browser, etc. In FIG. 2, a DFSN comprises one or more of an NGO Search Engine 201; an NGO Suggestion Engine 202; a weighting and ranking engine 203; account management 204; sponsor integration support; donor matching services; a DFSN API; and one or more data repositories such as NGO data repository 215, which maintains data on the NGOS; and user data repository 216, which maintains information on the various preferences, weightings, donation accounts of the participants.

The NGO Search Engine 201 is responsible for searching for organizations that match the criteria or factors submitted by a participant. This gives the participant explicit control over the kind of organizations that will be presented to him/her. Criteria include factors such as gender, age, religion, location, categories, special dates, numerical rankings, etc. Other criteria can be used as well.

The NGO suggestion engine 202 automatically provides lists of one or more organizations based upon, for example, information that the participant has provided in his/her profile, criteria such as that provided to the search engine 201, organizations that friends associated with the participant have also donated to, organizations that are similar to any of the above, etc. Many different algorithms can be employed, including statistical algorithms and Bayesian formulas, and other artificial intelligence type algorithms, that attempt to learn interests of the participant from the participant's prior donations.

The weighting and ranking engine 203 is responsible for implementing an interface that allows a participant to specify how a budget should be weighted between different organizations, different categories of organizations, designated organizations etc. Once weighted, the DFSN automatically distributes the participant's budget according to the weighting/ranking using whatever payment method and/or frequency the participant has indicated.

Account management 204 is responsible for maintaining the integrity and correctness of participants' designated donation accounts, as described further below.

The sponsor integration support module 205 allows 3^{rd} party sponsors to offer a user interaction experience in trade for donating to one or more organizations. In some embodiments the organizations are chosen by the sponsor—for example, a credit card company may donate a percentage of a customer's charges to one or more organizations of its choice. In other embodiments, the sponsor may donate some portion to organizations based upon the customer's selection(s), or some combination of both. User interaction experiences may include any type of activity one could encounter either over the network or even reporting results of off-network activity. For example, interactions may include activities such as taking surveys, viewing advertisements or videos, playing a game, charging purchases using a credit card, giving time at a community center, etc.

The donor matching services module 206 provides support for 3^{rd} parties to “match” contributions of the participant (i.e., the donor). Matches may take the form of money, services, or other value, such as stock. Entities that provide the match may be employer contributions or even private donors, such as family, friends, or anonymous individuals.

The Donation Facilitator Social Network Application Programming Interface (“API”) is a module optionally available to allow other third party code to integrate into an operating DFSN, or parts of one. This API can provide access to NGO data such as stored in NGO Data Repository 215 or participant data (as privacy settings warrant) such as stored in User Data Data Repository 216, such as the various preferences, weightings, donation accounts of the participants.

Other modules, fewer, and different modules may be incorporated as part of an embodiment of a Donation Facilitator Social Network system.

Although many of the examples described herein refer to a non-profit or an NGO, it is to be understood that the techniques described here are applicable to any organization capable of receiving money on a designated basis, whether or not the organization is “governmental or not” or “for profit” or not. In addition, the techniques described here could be embedded within another computing system, even restricted within a specific business, that is not socially networked per se, or on a more global unrestricted basis. Also, the automated distribution mechanism to user weighted and/or ranked designated organizations could be separately incorporated into other software and systems, such as a specific donation system.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Donation Facilitator Social Network System. In the following description, numerous specific details are set forth, such as user interface screens, data formats and code sequences, etc., in order to provide a thorough understanding of the described techniques. The embodiments described also can be practiced without some of the specific details described herein, or with other specific details, such as changes with respect to the ordering of the code flow, different code flows, different user interfaces, etc. Thus, the scope of the techniques and/or functions described are not limited by the particular order, selection, or decomposition of steps described with reference to any particular routine.

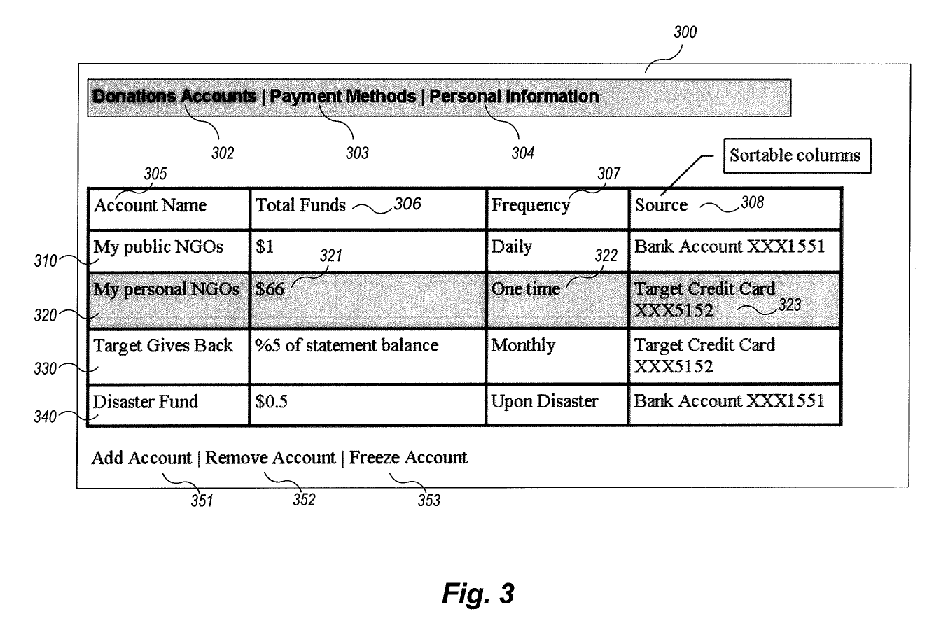

FIG. 3 is an example screen display of example donation accounts within an example donation facilitator social network. A user (donor or DFSN participant) may organize the accounts any way the user chooses. In the example shown, in the application page 300 displayed in the example DFSN, the donor can view donation accounts through control 302, change payment methods through control 303, or update personal information through control 304. In the example shown, the donor has defined and indicated four different types of accounts 305: public NGOs 310, personal NGOs 320, a sponsored account 330, and a disaster fund 340. By selecting the “add account” control 351, the donor can add additional account types and define them as desired. Different accounts may have different attributes depending upon the embodiment. By selecting the “remove account” control 352, the donor can remove an account type. Also, control 353 allows the donor to freeze a particular account type. For each account, a budget 306 is shown, an indication of frequency 307, and a payment source 308 for the donation. The budget 306 may be a fixed amount, a percentage, etc. The frequency may be a one-time donation, for example frequency 322 of personal NGOs 320, or a periodic interval such as daily, monthly, or upon a specific event such as a disaster. Under each account 305, a list of relevant accounts and their details is made available.

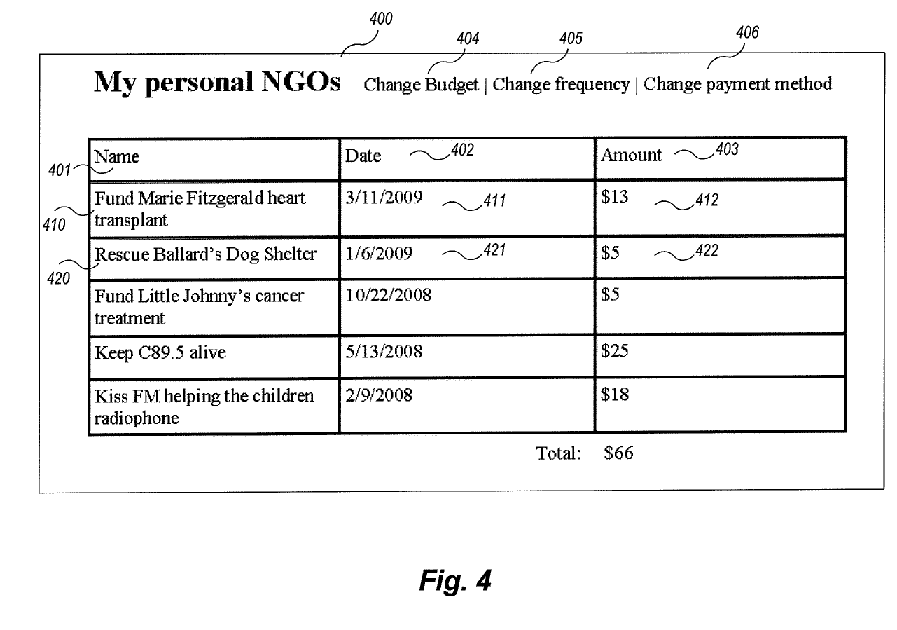

For example, when the donor selects account “My Personal NGOs” 320, a list of donation specifications for different funds is displayed that meet the criteria shown: that is, together the target funds (the organizations/individuals to which money is donated) receive a budget 321 of $66, on a one-time basis 322, using credit card 323. (A budget may be chosen and the system automatically divides it equally, or the “budget” may simply reflect the total donation amounts indicated.) FIG. 4 is an example screen display of an example arrangement of one time fixed donations within example donation account in an example donation facilitator social network. For each account in the My Personal NGOs account 400, the DFSN shows a name 401, a date 402 the donation was made, and an amount 403. For example on Mar. 11, 2009 (411), $13 (412) was donated to the Marie Fitzgerald heart transplant fund (410). It can be observed that the total one-time donated amounts add up to $66, reflected as the total funds 305 in FIG. 3. Because the DFSN tracks such information, it can be exported for other uses such as tax accounting. Also, using the user interface controls 404, 405, and 406, the donor can change the total budget, change the frequent of the funds in the account (for example, to a time interval or periodic basis such as “daily”), and can change the method of payment, respectively.

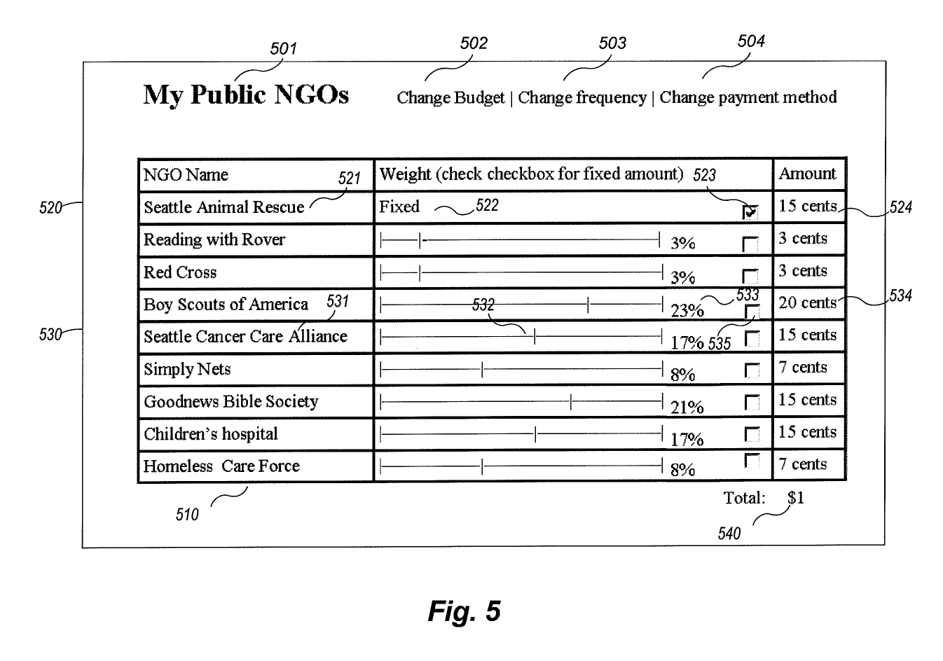

When the participant instead selects the “My public NGOs” account 310 in FIG. 3, the DFSN displays a list of funds and their donation specifications that are recipients of $1 on a daily basis. FIG. 5 is an example screen display of an example arrangement of weighted daily donations within an example account in an example donation facilitator social network. The account name 501 is shown, again with the ability to change the budget, change the donation frequency, and/or payment method through UI controls 502, 503, and 504, respectively. As shown, the “My public NGOs” account has nine different funds, each with a donation specification that is either a fixed amount (a portion of the budget 540, here $1) or a weighted amount. For example, the donation specification 520 indicates that the fund “Seattle Animal rescue” 521 will receive a fixed proportion 522, indicated by checking a box 523, here 15 cents amount 524 of one dollar—every day. In one embodiment, the donor can select a percentage of the budget to be donated to each fund. In the example shown, a sliding bar UI control is used. However, in other embodiments, other mechanisms and/or other UI controls, such as typing in a percentage may be used. For example, the donation specification 530 indicates that the fund “Seattle Cancer Care Alliance” 531 will receive a weighted percentage 532, which is seen to also be 15 cents of one dollar—every day. Other user interface mechanisms for allowing the donor to weigh and rank his/her donations can be incorporated or substituted.

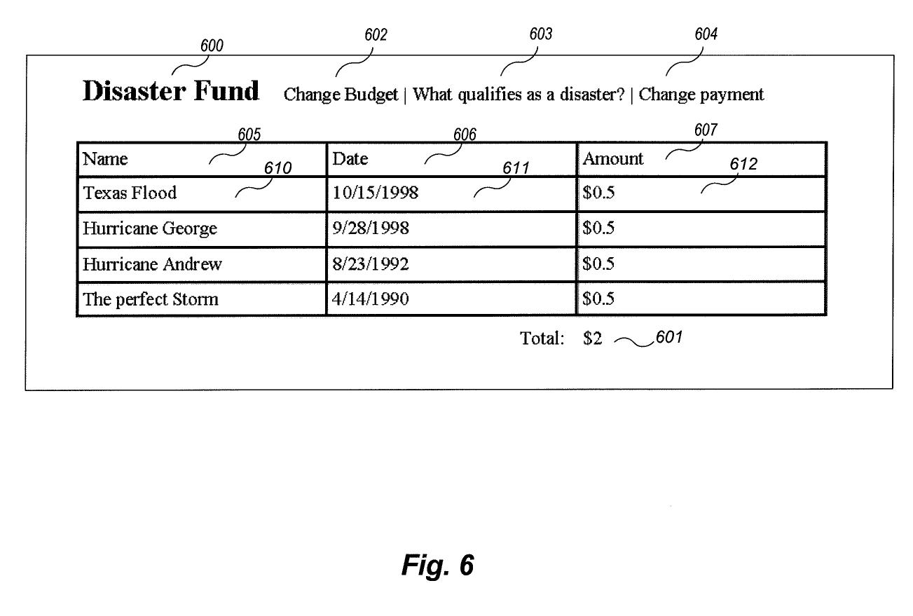

When the participant instead selects the “Disaster Fund” account 340 in FIG. 3, the DFSN displays a list of the disaster funds that the donor has donated to. FIG. 6 is an example screen display of an example arrangement of a disaster fund donations in an example donation facilitator social network. The account name 600 is shown, with the ability to change the budget, determine what qualifies as a disaster (i.e., change the “frequency” of an event), and/or payment method through UI controls 602, 603, and 604, respectively. For each fund in Disaster Funds account 600, the DFSN shows a name 605, a date 606 the donation was made, and an amount 603. For example on Oct. 15, 1998 (611), $0.50 (612) was donated to the Texas Flood disaster fund (610). It can be observed that the disaster donated amounts are reflected in the funds 306—frequency 307, which specifies $0.50 for each disaster in FIG. 3. Because the DFSN tracks such information, it can be exported for other uses such as tax accounting. In other embodiments different methods for dividing up a budgeted amount could be incorporated, such as a percentage of money spent on other accounts.

Again, other user interfaces for arranging funds into different accounts, for indicating donation specification and account specifications, etc. may be similarly incorporated.

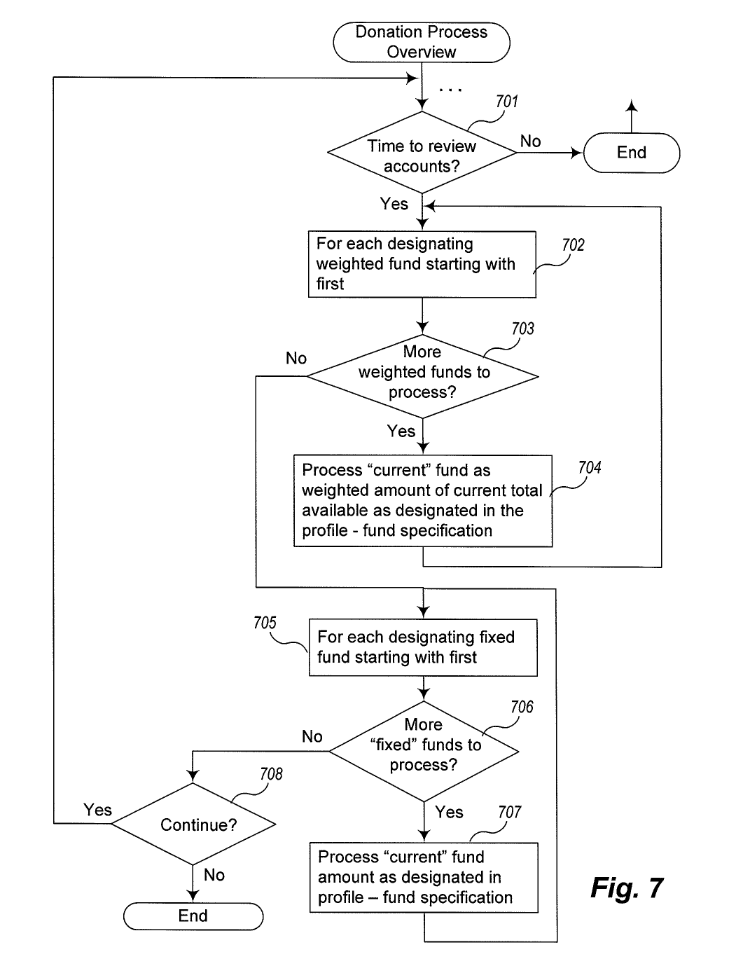

FIG. 7 is an example flow diagram of an overview of an example donation process in an example donation facilitator social network system. The donation process processes the fund donation specifications in each fund in each account on the frequency indicated. The process is run typically as frequently as the most frequent occurring donation. In block 701, the DFSN determines whether it is time to review one or more funds with one or more accounts. If so, the block continues in block 702, else ends. (The process may be implemented as a daemon process and lay dormant until receiving an applicable event.) In blocks 702-704, the DFSN performs a loop to process the weighted donations to funds. In particular, for each target fund that has a weighted or variable frequency starting with the first (block 702), the DFSN determines whether there are more such donation specifications to process (block 703), or not. If so, the DFSN continues in block 704 to process the donation specification for the particular (current) fund; otherwise, the DFSN continues to block 705 to process the fixed donation type funds. Once the DFSN has finished processing the weighted donation to the current fund in block 704, it returns to the beginning of the loop in block 702 to process the next such fund.

In blocks 705-707, the DFSN performs a loop to process the funds having fixed amount donations. In particular, for each target fund starting with the first (705), the DFSN determines whether there are more such donation specifications to process (block 706), or not. If so, the DFSN continues in block 707 to process the donation specification for the particular (current) fund; otherwise, the DFSN continues to block 708. Once the DFSN has finished processing the fixed donation to the current fund in block 707, the DFSN returns to the beginning of the loop in block 705 to process the next such fund. In block 708 the DFSN determines whether to continue with other processing, such as logging activity or reporting errors, and if so continues processing, otherwise, terminates.

Note that FIG. 7 for simplicity does not show the extra looping that may be implemented to handle that the donation specifications may be hierarchically organized into accounts. This extra processing may be handled in the routine show in FIG. 7 or at a higher level. Also, for simplicity, other types of donation specification handling is not shown, such as disaster event driven donations, as this can be handled on a case by case basis.

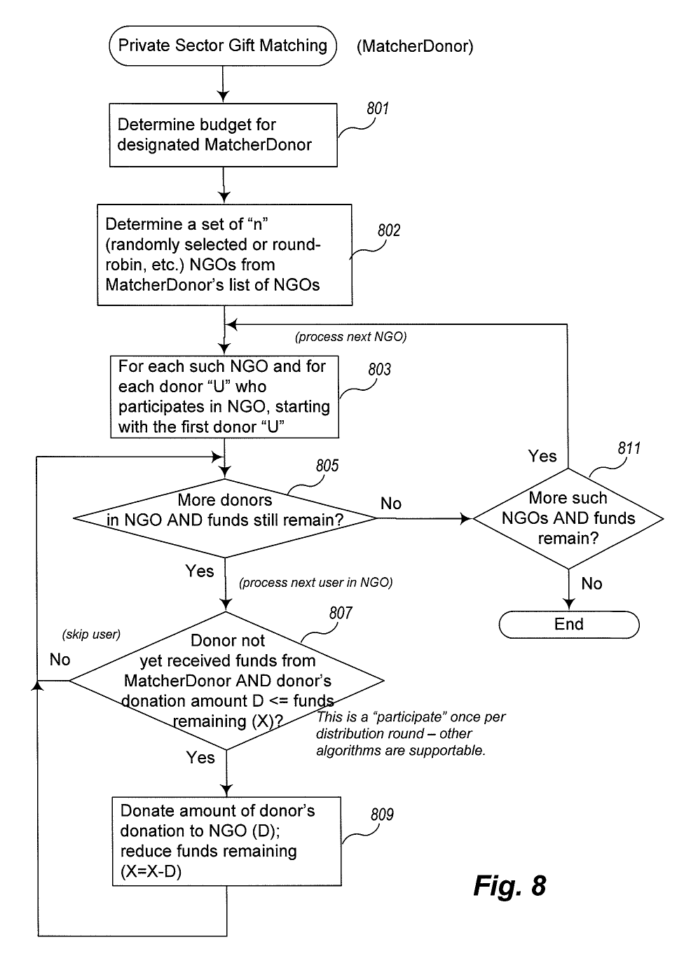

FIG. 8 is an example flow diagram of private sector gift matching in an example donation facilitator social network. As mentioned earlier, gift matching may be offered by an institution such as an employer or a private donor—even one connected to the participant donor's social network (i.e., gift matching between participants). The example described here is the latter, as many techniques are known for supporting and managing employer matching donations. The technique described in FIG. 8 can be implemented as a “plug-in” to other software as well, which then uses the DFSN API to communicate with the DFSN to fund possible donor funds according to donation specifications for one or more participant donors. In one embodiment, the participant who wishes to match donations of other participants will identify him or herself to the DFSN, sign the appropriate terms and conditions, etc. As part of this process, the donor who wishes to match other donors (here called the “matcher donor”) will specify a budget that can be used by the DFSN to match other donor's donations to funds. At various times, the private sector gift matching routine of FIG. 8 is executed to distribute the budgeted amount to various funds. The algorithm used by FIG. 8 is one such algorithm, others can be used. The focus of the method of FIG. 8 is to distribute funds fairly using randomly selected NGOs and donors to those NGOs.

In block 801, the DFSN determines (e.g., retrieves if already designated) the budget for the designated matcher donor (in flow diagram, the “MatcherDonor”). Money funds “X” corresponds to this budget. In block 802, the DFSN routine determines a set of “n” NGOs from the MatcherDonor's list to receive the budget money “X.” As stated, in this embodiment the selection of NGOs to receive the matching funds is randomly determined however many other selection algorithms, for example, those that take into account past history donations, can be used. In blocks 803-811, a loop is executed to distribute the funds “X” to as many other donors of the selected set of “n” NGOs as possible.

Specifically, in block 803, the DFSN selects each such NGO from set “n” and each user donor “U” who is a participant donor in the NGO, starting with the first. In block 805, the DFSN checks to see if there are still more participant donors in the NGO and funds “X” still remain. If so, the DFSN proceeds to block 807 to continue distribution of funds to the current NGO, otherwise proceeds to block 811 to process potentially another NGO. In block 807, the DFSN checks to see if the current donor “U” has not yet received funds (for this NGO) from the matcher donor and there still remains money (“X”) to be distributed. If both conditions are true, then in block 809, the funds “X” are used to match the donor “U” 's contribution (“D”), and the matching fund is reduced by this amount. The DFSN then returns to block 805 to process the next donor “U” who has contributed to the current NGO. If, on the other hand, in block 807 either the donor “U” has already received matching funds from the matcher donor (even for another NGO) or if insufficient matching funds are left, then the DFSN proceeds back to block 805, where either another donor “U” will be selected, or, if insufficient funds remain, the DFSN will proceed via block 811 to exit.

If in block 805 either there are no more donors “U” who have participated in donating to the current NGO or insufficient funds remain, then, as discussed the DFSN proceeds to block 811. In block 811, the DFSN checks to see if there is another NGO to process and there are still funds “X”, and, if so, proceeds to block 803 to select the next NGO from the random set “n” to process. Otherwise, the DFSN exits.

In FIG. 8, the user donor s “U” refer to other donors that the DFSN is aware of. That is, there may be participant donors in an NGO who have funded the NGO outside of the environment of the DFSN. The technique of FIG. 8 is meant to reward those in the network. It is contemplated, however, that other scenarios which reward donors “U” outside the network might also have some of their donations matched, assuming the donation information could be retrieved electronically, perhaps at even a reduced amount. Lots of other variations are possible and presumed to be within the purview of this technique.

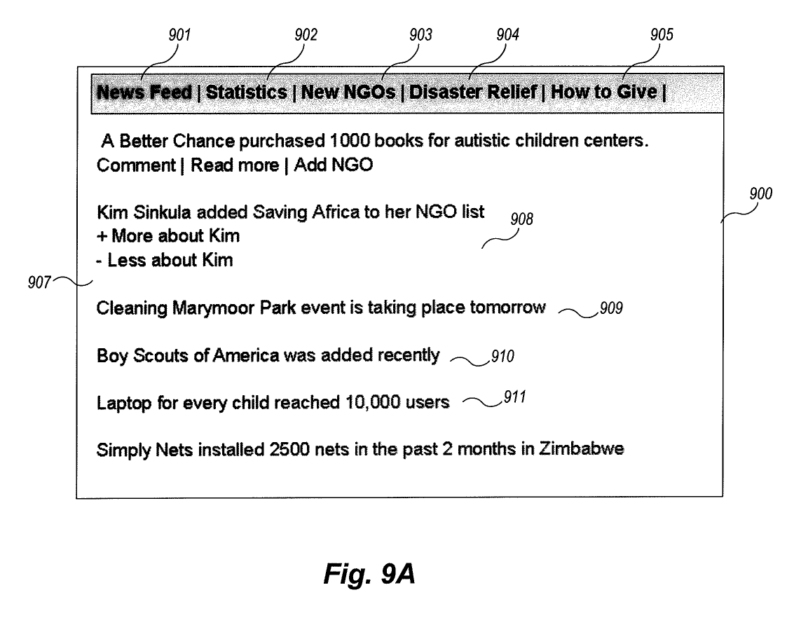

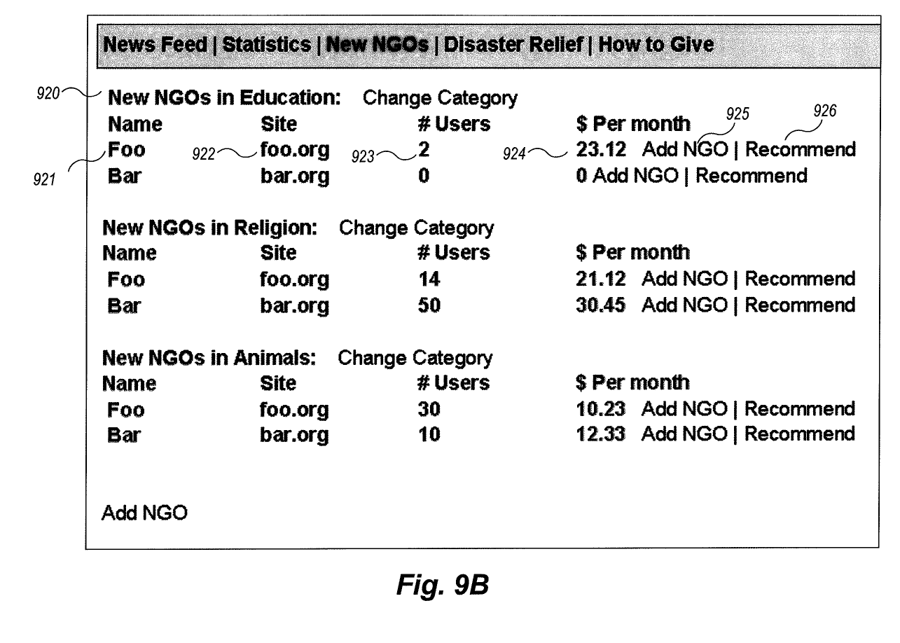

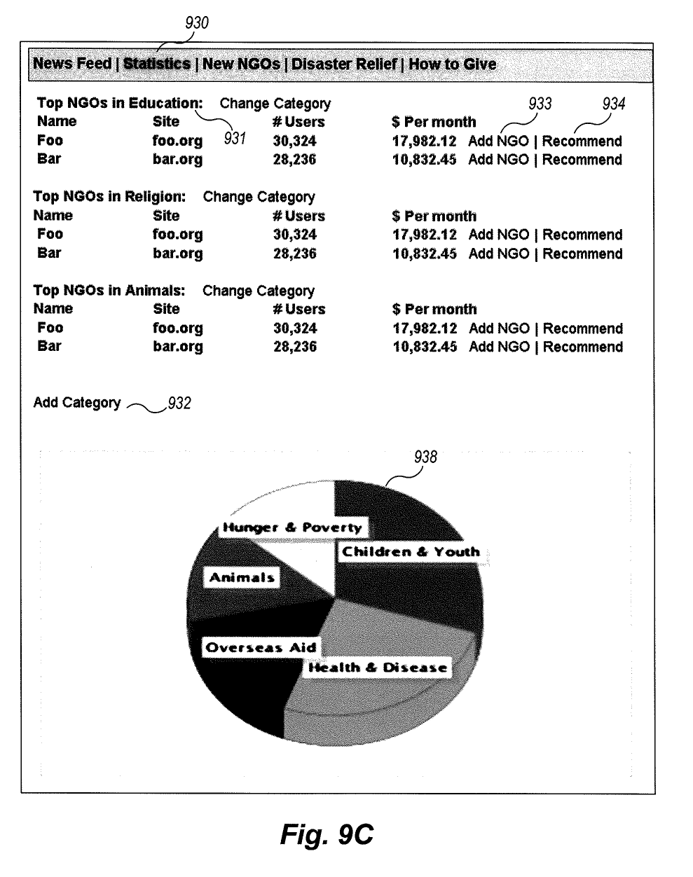

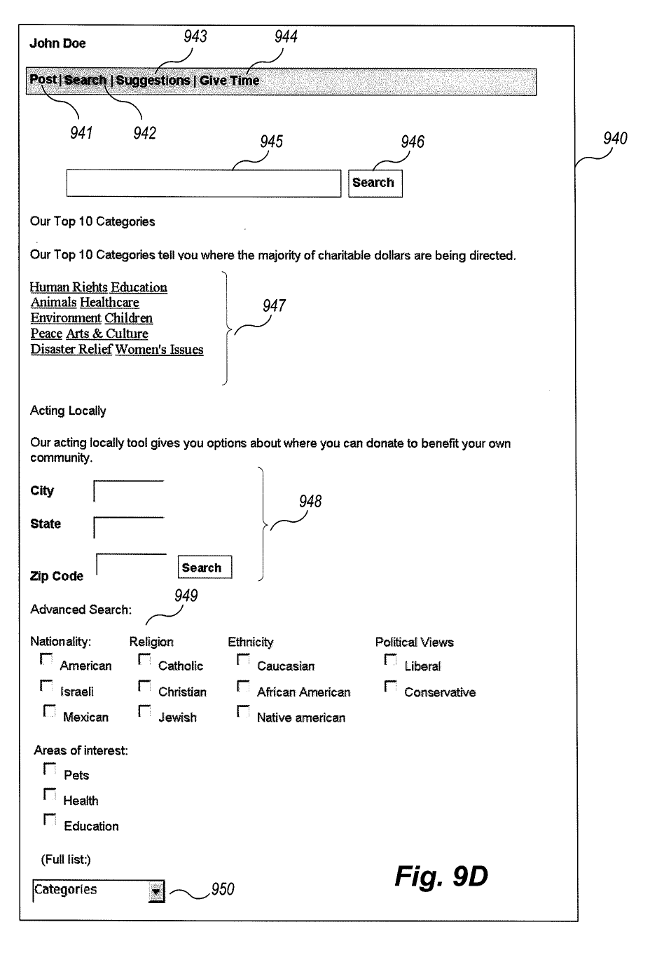

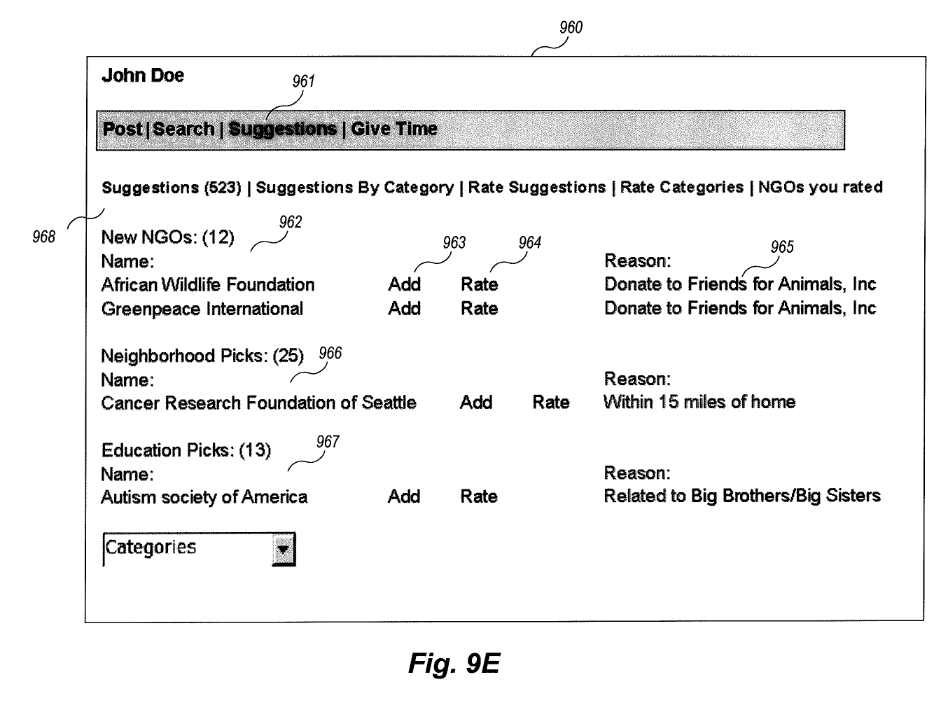

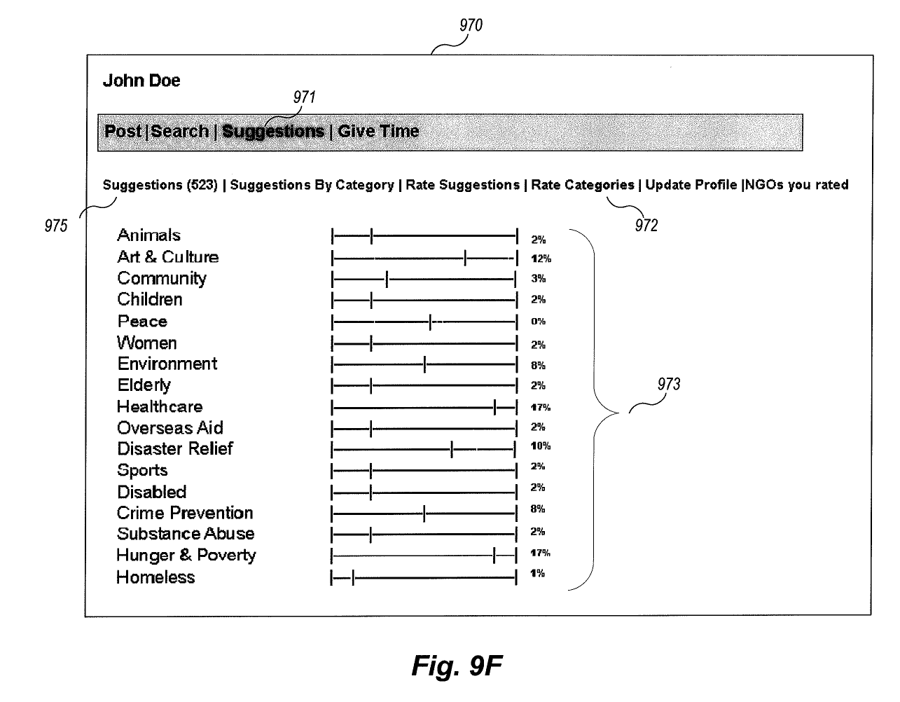

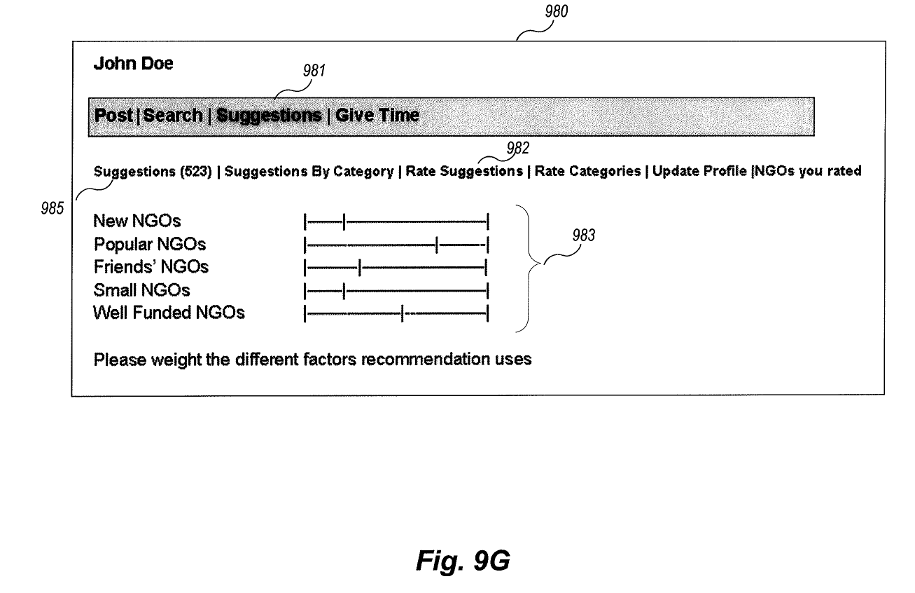

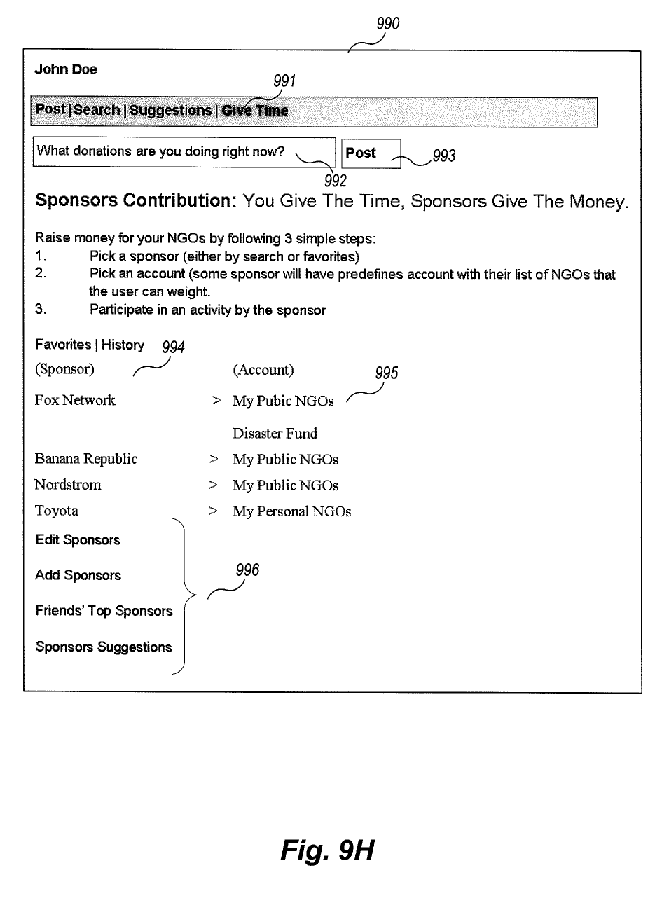

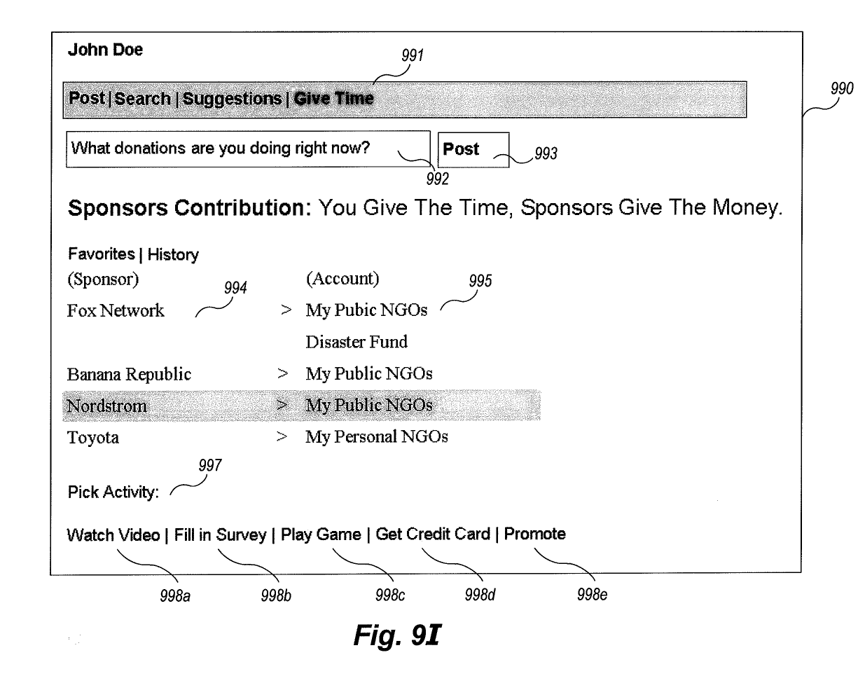

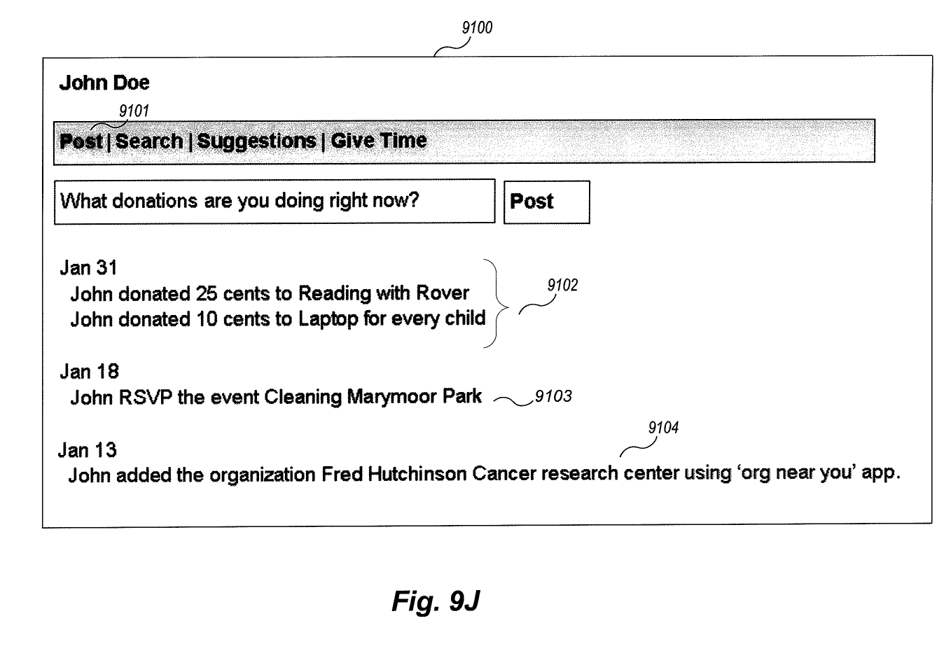

FIGS. 9A-9J are example screen displays of example features in an example donation facilitator social network application for implementing an automated weighted donation system. Only some of the features are touched on herein, as they are merely exemplary of the types of features that may be implemented.

Example screen display 900 provides some example social networking kinds of activities to the donor user of the DFSN. The display defaults to a news feed screen. As seen on the action bar, the donor user can select to see the news feed (using news feed link 901), statistics about NGOs (using statistics link 902), what new NGOs have been added to the system (using New NGOs link 903), what events are in need of disaster relief (using link 904) and instructions on how to donate (using link 905). Display 907 shows example news updates that may relate to the different donors connected socially via the DFSN. Like many social network sites, the idea is for a user (donor) to give as much or as little information as desired to the other donors he or she is connected to. Here, news events 909-911 demonstrate example news regarding donation activities. For example news event 909 tells something about an event going on that may need funding. News excerpt 910 describes a new NGO that was recently added. News event 908 describes a new NGO that a particular donor has added to her list. This is one way for a donor to figure out what NGOs the donor's friends are funding.

When the donor selects the New NGO link 903 in display 900 of FIG. 9A, the DFSN navigates to a display screen 9B that shows the NGOs that have recently been added in each “category” of organization. In some embodiments, the DFSN determines the categories, or at least a default category. In other embodiments, the categories are determined by the participants in the social network. For example, in display screen 9B, new organizations in the Education category 920 are displayed. For each category, the DFSN displays the name 921 of the organization, a link 922 to the organization's website, the number of DFSN participants 923 who have donated and the amount per month 924 the fund is currently receiving. Using links 925 and 926, the donor can easily add the NGO to his or her accounts, or recommend it to someone else.

When the donor selects the Statistics link 902 in display 900 of FIG. 9A, the DFSN navigates to a display screen 9C that shows statistics regarding the number of (or other statistics) NGOs in each category. In the example shown, the top NGOs in each category are shown, along with corresponding statistics. For example, the top NGOs in the education category 931 are shown with the number of donors and their donated dollar amounts per month. Again the participant can easily add the NGO to the participant's accounts or recommend it using links 933 and 934. In addition, other statistics can be represented. For example, chart 938 shows the recipient groups or topics addresses by these NGOs giving a different view than merely categorization.

The example embodiment of the DFSN presents additional information to the user/participant when the user selects his or her profile, for example, by selecting his name, or a “home” icon, or other mechanism. FIG. 9D is an example screen display (e.g., a web page) of the DFSN after the donor has selected a search link. In particular, as shown in FIG. 9D, the action bar displays a post link 941, a search link 942, a suggestions link 943, and a give time link 944. The search link 942 navigates to a user interface (e.g., a web page) that allows the participant to specify particular parameters and filters to the DFSN so that the DFSN can find NGOs (or other organizations) meeting the participant's criteria. The suggestions link 943 navigates to a user interface (e.g., a web page) where the DFSN can suggest different organizations to which the participant may wish to donate based upon any number of a variety of factors such as: attributes listed in the participant's profile, which organizations the participant's social network (i.e., “friends”) have donated to, which organizations are similar to those the participant already donates to, etc. The give time link 944 navigates to a user interface (e.g., a web page) where the sponsors are linked in to provide activities for which funds are donated in exchange for the participant's time.

The search page 940 of FIG. 9D offers the participant an ability to search for one or more NGOs that meet different criteria specified a number of ways. For example, the participant can enter keywords in edit field 945. In addition, the participant can search for NGOs by specifying a category for example using the category link 948 to the top categories. In addition, the participant can find local NGOs for donations in the participant's local community by entering location information into fields 948. Also, the participant can filter the search based upon other factors such as nationality, religion, ethnicity, political view, social associations, tags, and/or areas of interest as shown in advanced search field 949. The participant can also search a complete list of organizations by selecting one or more categories from the category dropdown 950. Other factors and criteria can be similarly accommodated.

FIG. 9E is an example screen display (e.g., a web page) 960 of the DFSN after the donor has selected a suggestions link 961 from the action bar. Suggestions are a means for the DFSN to offer up interesting organizations for the participant to consider making donations to. These NGOs are typically suggested based upon similarity to other organizations to which the participant already donates, that they are in the local community of the participant, are donated to already by friends of the participant, etc. For example, the DFSN is shown offering several newly added NGOs 962 based upon information that they are similar to an organization “Friends for Animals, Inc” to which the participant already donates. A reason 965 with a link to the similar organization is shown. The participant is offered an easy means to add or rate the suggested NGO via controls 963 and 964, respectively. In FIG. 9E, the DFSN is also suggesting an NGO 966 that is in the neighborhood of the participant.

In the suggestions user interface, there is also a set of links 968 that allows the participant to navigate to view different aspects of the suggestions, namely the suggestions themselves as shown in FIG. 9E, suggestions by category, the ability to rate suggestions and rate categories, and to see the NGOs the participant has rated.

FIG. 9F is an example display screen of the user interface (e.g., web page) resulting from navigation to the rate categories link 972 in the set of links 975. Here, the participant can indicate using percentage weightings his or her interest in particular categories of NGOs.

FIG. 9G is an example display screen of the user interface (e.g., web page) resulting from navigation to the rate suggestions link 982 in the set of links 975. Here, the participant can indicate to the DFSN suggestions engine and rate what importance certain types of suggestions have to the participant. For example, in the scenario shown in weighting control 983, popular NGOs are rated as more important to the participant than small or new NGOs. Slider bars are shown here, however, any other user interface control or mechanism that can be used to indicate relative weights can be used.

FIG. 9H is an example screen display (e.g., a web page) 990 of the DFSN after the donor has selected a give time link 991 from the action bar. This user interface provides a way for sponsors to be linked in to provide activities for which funds are donated by the sponsor in exchange for the participant's time. As described on the page, a sponsor gives money in response to the participant doing something. Note that one of the ways that a participant may give “time” is to advertise on behalf of the sponsor. In return, the sponsor can donate money to one or more organizations of the participant's choice. In the example illustrated in FIG. 9H, sponsor list 994 shows a list of 4 sponsors, each linked to one of the accounts 995 of the participant. Links 996 allows the participant to edit a sponsor specification (for example to associate one with a different account), add a new sponsor, find the top sponsors of the participant's friends, and obtain suggestions of sponsors from the DFSN, similar to how the DFSN suggestions NGOs.

When the participant selects a particular sponsor, the participant is navigated to a page specific to that sponsor's activities. For example, FIG. 9I shows a set of activities 998a-998e that the participant can select from in order to cause the sponsor to donate to the NGO—here of the participant's choice, as seen from the account list 995 associated with the sponsors 994. In other embodiments the donation from the sponsor may go towards preselected NGOs or to a selected NGO from a list provided by the sponsor, etc. In the example shown, the participant can watch a video (link 998a), fill in a survey (link 998b), play a game (link 998c), obtain a credit card (link 998d), promote a product or service (link 998e), or any other networked or off-network activity (not shown. Promotion of a product or service (link 998e), in some embodiments, may include supporting the participant to include advertising on behalf of the NGO in some other venue (e.g., a separate web page) controlled by the participant. In that scenario, when the advertisement is selected (or otherwise shown or acted upon to create notification as determined by the sponsor), the sponsor donates.

FIG. 9J is an example screen display (e.g., a web page) 9100 of the DFSN after the donor has selected a post link 9101 from the action bar. The post user interface allows the participant to post information relating to his or her donations, donation events, NGO additions to his or her accounts, etc. For example, posting 9102 shows two different donations that “John” has made. Posting 9104 shows a new organization that John has added to his accounts. With the posts are links to the NGOs so that the participant's friends can obtain instantaneous information about the organization recipient of the donation. Other postings can also be made, for example, news updates can also be posted by NGOs.

One of the things of note with the interface shown in FIGS. 9A-9J is that the size of the donation does not dictate (necessarily) the importance of sharing the donation and its contribution to the social community being tracked and promoted by the DFSN. Also, as described earlier, many other interfaces for implementing embodiments of an example DFSN are possible. The displays shown and described relative to FIGS. 1, 3-6, and 9A-9J are only one such embodiment.

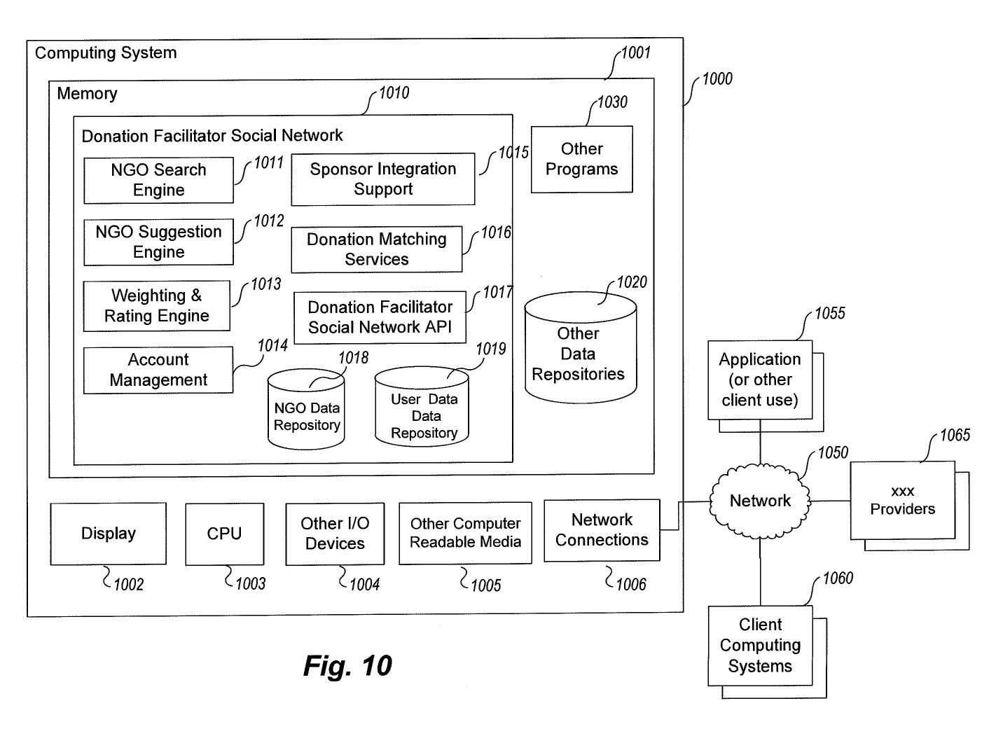

FIG. 10 is an example block diagram of a computing system for practicing embodiments of an example donation facilitator social network system. Note that a general purpose or a special purpose computing system suitably instructed may be used to implement a DFSN. Further, the DFSN may be implemented in software, hardware, firmware, or in some combination to achieve the capabilities described herein.

The computing system 1000 may comprise one or more server and/or client computing systems and may span distributed locations. In addition, each block shown may represent one or more such blocks as appropriate to a specific embodiment or may be combined with other blocks. Moreover, the various blocks of the Donation Facilitator Social Network 1010 may physically reside on one or more machines, which use standard (e.g., TCP/IP) or proprietary interprocess communication mechanisms to communicate with each other.

In the embodiment shown, computer system 1000 comprises a computer memory (“memory”) 1001, a display 1002, one or more Central Processing Units (“CPU”) 1003, Input/Output devices 1004 (e.g., keyboard, mouse, CRT or LCD display, etc.), other computer-readable media 1005, and one or more network connections 1006. The DFSN 1010 is shown residing in memory 1001. In other embodiments, some portion of the contents, some of, or all of the components of the DFSN 1010 may be stored on and/or transmitted over the other computer-readable media 1005. The components of the Donation Facilitator Social Network 1010 preferably execute on one or more CPUs 1003 and manage the automated donation facilities using the donor's donation specifications, as described herein. Other code or programs 10320 and potentially other data repositories, such as data repository 1020, also reside in the memory 1001, and preferably execute on one or more CPUs 1003. Of note, one or more of the components in FIG. 10 may not be present in any specific implementation. For example, some embodiments embedded in other software may not provide means for user input or display.

In a typical embodiment, the DFSN 1010 includes one or more NGO Search Engines 1011, one or more NGO Suggestion Engines 1012, one or more Weighting and Rating Engines 1030, one or more Account Management modules, Sponsor Integration Support 1015, Donor Matching Services 1016, an API 1017, an NGO Data Repository 1018, and a User Data Data Repository 1019. In at least some embodiments, the Weighting and Rating Engine 1013 is provided external to the DFSN and is available, potentially, over one or more networks 1050. The other engines may be similarly deployed external to the DFSN and made available, potentially, over one or more networks 1050. Other and/or different modules may be implemented. In addition, the DFSN may interact via a network 1050 with application or client code 1055 that uses donation information computed by the Search and Suggestion Engines 1011 and 1012 such as to provide targeted advertising, one or more client computing systems 1060 such as donor personal computers, and/or one or more third-party information provider systems 1065, such as third part systems that integrate via the Sponsor Integration Support 1015 to provide added donor user (participant) experiences. Also, of note, the NGO Data Repository 1018 may be provided external to the DFSN as well, for example in a DBMS or knowledge base accessible over one or more networks 1050.

In an example embodiment, components/modules of the DFSN 1010 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by a DFSN implementation.

In addition, programming interfaces to the data stored as part of the DFSN 1010 (e.g., in the data repositories 1018 and 1019) can be available by standard means such as through C, C++, C#, and Java APIs; libraries for accessing files, databases, or other data repositories; through scripting or markup languages such as XML; or through Web servers, FTP servers, or other types of servers providing access to stored data. The NGO Data Repository 1018 and User Data Data Repository 1019 may be implemented as one or more database systems, file systems, or any other method known in the art for storing such information, or any combination of the above, including implementation using distributed computing techniques.

Also the example DFSN 1010 may be implemented in a distributed environment comprising multiple, even heterogeneous, computer systems and networks. For example, in one embodiment, the NGO Search Engine 1011, the Weighting and Rating Engine 1013, and the NGO Data Repository 1018 are all located in physically different computer systems. In another embodiment, various modules of the DFSN 1010 are hosted each on a separate server machine and may be remotely located from the tables which are stored in the data repositories 1018 and 1019. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of a DFSN.

Furthermore, in some embodiments, some or all of the components of the DFSN may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored (e.g., as executable or other machine readable software instructions or structured data) on a computer-readable medium (e.g., a hard disk; a memory; a network; or a portable media article to be read by an appropriate drive or via an appropriate connection). Some or all of the system components and data structures may also be transmitted via generated data signals (e.g., as part of a carrier wave or other analog or digital propagated signal) on a variety of computer-readable transmission mediums, such as media 1005, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of the present disclosure. For example, the methods and systems for performing weighted donations on a frequent basis discussed herein are applicable to other architectures other than a client-server or Internet architecture. Also, the methods, techniques, and systems discussed herein are applicable to differing protocols, communication media (optical, wireless, cable, etc.) and devices (such as wireless handsets, electronic organizers, cellular phones, personal digital assistants, portable email machines, game machines, pagers, navigation devices such as GPS receivers, etc.).

1. A method in a social network computing system for automatically distributing funds to a plurality of non-governmental organizations comprising:
for each of the plurality of non-governmental organizations, receiving a donation specification that indicates a participant specified donation weighting relative to a total amount of funds to be distributed at a designated frequency; and
at a time indicated by the designated frequency, automatically causing the total amount of funds to be distributed to each of the non-governmental organizations in accordance with the received donation specifications such that a portion of the total amount of funds is distributed to each organization on behalf of the participant in accordance with the participant specified donation weighting for the organization.

2. The method of claim 1 wherein the donation weightings are specified as percentages of the total amount of funds to be distributed.

3. The method of claim 1 wherein a user interface is presented for enabling the participant to specify a donation weighting by through a graphical control.

4. The method of claim 1, further comprising:
forwarding suggestions of additional non-governmental organizations to which the participant could consider donating based at least in part upon the donation weightings of the plurality of non-governmental organization the participant is already donating to.

5. The method of claim 1, further comprising:
causing a sponsor to donate additional funds to one or more of the plurality of non-governmental organizations in exchange for the participant engaging in one or more sponsored activities.

6. The method of claim 5 wherein the activities comprise at least one of viewing a video, filling in a survey, playing a game, applying for a credit card, or sponsoring an advertisement.

7. The method of claim 5 wherein the additional funds are caused to be donated by the sponsor as a percentage of participant spending.

8. The method of claim 1 wherein the total amount of funds is less than ten dollars and the designated frequency is daily.

9. The method of claim 1 wherein the social network computing systems provides a user interface for friends of the participant to learn about the donation activities of the participant.

10. The method of claim 9 wherein the donation activities include organizations newly added to the plurality of non-governmental organizations associated with the participant.

11. The method of claim 9 where the donation activities include a list of donations that the participant has made.

12. The method of claim 1, further comprising:
automatically causing an amount of funds to be distributed to a designated disaster fund in accordance with a donation specification of the participant that specifies how much money is to be distributed to disaster funds.

13. The method of claim 1, further comprising:
searching for additional non-governmental organizations based upon participant specified characteristics.

14. The method of claim 13 wherein the characteristics include at least one of location, religion, or ethnicity.

15. A computer-readable medium containing instructions that control a computer processor to automatically distribute funds of a participant as donations to a plurality of organizations, by performing a method comprising:
receiving an indication of a donation specification for each of the plurality of organizations, the donation specification specifying a portion of the funds to be distributed to the organization based upon the weighting of the organization relative to the rest of the organizations in the plurality of organizations and a frequency for donation;
at a time dictated by the frequency for donation, causing a portion of the total funds to be automatically distributed to each of the plurality of organizations in accordance with the respective weighting of the organization.

16. The computer-readable medium of claim 15 wherein the weighting is specified as a percentage of the total funds available to be donated to the plurality of organizations by the participant.

17. The computer-readable medium of claim 15 wherein the plurality of organizations are non-governmental organizations.

18. The computer-readable medium of claim 15 wherein the frequency for donation of at least some of the donations are daily.

19. The computer-readable medium of claim 15, the method further comprising:
causing a sponsor to donate additional funds to one or more of the plurality of non- governmental organizations in exchange for the participant engaging in one or more sponsored activities.

20. A social network computing system comprising:
a memory;
a search engine configured, when executed by a computer processor, to search for non-governmental organizations that meet participant specified criteria, including one or more categories or location information;
a suggestion engine configured, when executed by a computer processor, to provide one or more suggested organizations based upon the participants past donation behavior; and
a weighting and rating engine configured, when executed by a computer processor to enable the participant to weight contributions to a set of non-governmental organizations chosen by the participant and to rate organizations for use by other participants in the social network computing system.

21. The computing system of claim 20, further comprising:
a sponsor integration support module configured, when executed by a computer processor, to provide donations from the sponsor in exchange for the participant engaging in one or more activities.

22. The computing system of claim 20, further comprising:
a donation matching service module configured, when executed by a computer processor, to provide a matching donation from a different participant.
